(19) United States
(12) Patent Application Publication
(10) Pub. No.: US 2003/0221485 A1
(43) Pub. Date: Dec. 4, 2003

(54) Liquid level sensing system utilizing a capillary tube

(76) Inventor: Ikuo Toki, Tokyo (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/452,399

(22) Filed: Jun. 2, 2003

(30) Foreign Application Priority Data
Jun. 3, 2002 (JP) 161161/2002

(51) Int. Cl. G01F 23/00

(52) U.S. Cl. 73/295

(57) ABSTRACT

An upright capillary tube is located at a position in a liquid container such that its lower end can be reached by the surface of the liquid level in the container as the liquid level rises and falls with changes in the amount of liquid in the container. A thermal sensor, e.g., a thermistor is provided on the capillary tube. As the liquid level rises and reaches the lower end of the capillary tube, the liquid rises in the tube due to surface tension. As the liquid in the capillary tube reaches the location of the thermal sensor, the sensor responds to a temperature change to detect the liquid level. The capillary sensing system can be miniaturized and is capable of superior sensitivity.

### FIELD OF THE INVENTION

This invention relates to a liquid level sensing system.

### BACKGROUND OF THE INVENTION

A typical conventional liquid level sensing system, incorporates a float, and determines the liquid level by the vertical position of the float. However, in the float-type level sensing system, the float displaces an amount of liquid equal to the weight of the float. As a result the apparatus as a whole needs to be relatively large, since the liquid depth must be sufficient to allow float to be buoyantly supported by the liquid. Another problem with the float-type sensing system is that it exhibits insufficient sensitivity for some applications.

Other types of liquid level sensing systems include the temperature detection type, the ultrasonic type, and laser type. However, problems have been encountered in miniaturizing all of these sensing systems, due to the effect of the dead band distance.

### SUMMARY OF THE INVENTION

The invention solves the above problems by providing a liquid level sensor comprising a capillary tube having a lower end located at a position such that it can be reached by the surface of a liquid in a liquid-containing system in which the liquid level rises and falls. A thermal sensor is provided on the capillary tube at a position spaced from the lower end of the tube. The thermal sensor is responsive to the presence of liquid in the capillary tube in proximity to the position of the thermal sensor. The presence of the liquid surface at the position of the lower end of the capillary tube is detected by the thermal sensor as the liquid rises in the capillary tube and reaches a position in proximity to the position of the thermal sensor.

In a preferred embodiment, the capillary tube has upper and lower end openings, both of which are connected to, and in communication with, the inside of the liquid container.

The thermal sensor may comprise a pair of thermally responsive sensing elements, both in proximity to a position spaced from the lower end of the capillary tube. These thermally responsive sensing elements may be disposed in a bridge circuit to provide for very sensitive liquid level detection.

The liquid level sensing system according to the invention eliminates the need for a float and the need to provide for the draft depth of the float. Consequently, the system can be miniaturized.

Precise liquid level detection can be achieved by setting the diameter of the capillary tube according to the properties, such as surface tension, which affect the height to which the liquid rises in a capillary tube.

### BRIEF DESCRIPTION OF THE DRAWINGS

FIG. 1(a) is a cross-sectional view of a liquid level sensing system in accordance with the invention;

FIGS. 1(b) and 1(c) are schematic views illustrating the capillary phenomenon;

FIG. 2 is cross-sectional view of a liquid level sensing system in accordance with another embodiment of the invention;

FIG. 3 is a cross-sectional view showing a liquid level sensing system according to the invention installed in a liquid container;

FIG. 4 is a cross-sectional view of a liquid level sensing system in accordance with still another embodiment of the invention; and

FIG. 5 is a cross-sectional view showing another example of the utilization of a liquid level sensing system according to the invention.

### DETAILED DESCRIPTION OF THE PREFERRED EMBODIMENTS

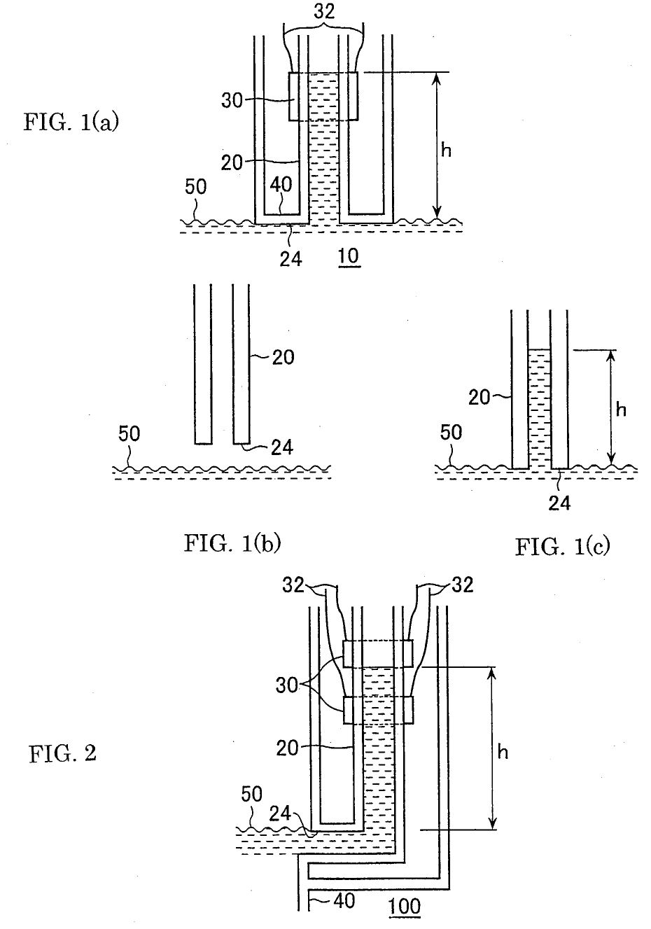

As shown in FIG. 1, a liquid level sensing system 10 according to the invention comprises a capillary tube 20 and a thermal sensor 30, e.g., a thermistor, wound around the capillary tube 20. The tube 20 is disposed in an upright condition, with its lower end 24 in a liquid container 40 at a level such that it can be in contact with the liquid surface 50 when the amount of liquid in the container increases, causing the position of the liquid surface 50 to rise.

When the liquid surface 50 rises and reaches the lower end 24 of the capillary tube 20, as a result of the capillary phenomenon, the liquid will rise to a height h in the tube due to surface tension. When the liquid rises to the proximity of the thermal sensor 30, it causes a temperature change to which the sensor responds by delivering an electrical signal through wires 32.

A thermistor wound around the capillary tube 20, or a small thermistor tip comprising a self-heating thermal sensing element attached to the capillary tube, maybe used as the thermal sensor 30. A thermistor wound around the capillary tube as a thermal sensor affords better sensitivity, since the entire internal surface of the thermistor functions as a sensor. Although one thermistor is sufficient for many applications, a plurality of thermistors may be provided, at additional cost, for improved sensitivity.

As shown in FIG. 1(b), while the liquid surface 50 is below the level of the lower end 24 of the capillary tube 20, liquid is not drawn up into the capillary tube. However, as shown in FIG. 1(c), when the liquid surface 50 reaches the lower end 24 of the capillary tube 20, surface tension causes the liquid to rise in the capillary tube 20 to a height which is considerably above the liquid level 50. The invention fully utilized this “capillary phenomenon”. The height h, to which liquid rises in a capillary tube 20 due may be obtained by the following equation:

h=2ƒÁcosƒ [symbol] /rƒfÏg

where, ƒÁ is a liquid surface tension;

ƒ [symbol] is the contact angle;

r is the radius of the interior of the capillary tube;

ƒÏ is the liquid density; and

g is the gravitational acceleration.

The radius r of the capillary tube 20 may be selected based on the above equation so that an appropriate value for height h may be obtained.

Experiments were conducted on capillary tubes having internal diameters in the range from 0.25 mm to 0.8 mm. The experiments confirmed that the preferred diameter of the capillary tube 20 was 0.7 mm in the case where liquid was TEOS or ethanol. TEOS stands for “tetraethylorthosilicate”.

In the embodiment shown in FIG. 2 liquid level sensing system 100 comprises a pair of thermal sensors 30. These sensors are disposed one above the other on a capillary tube, and are connected electrically as branches of a bridge circuit (not shown). As will be apparent, a very slight movement of the liquid in the capillary in the vicinity of the thermal sensors can cause a large shift in the output of the bridge circuit, and can even change the polarity of the output, and consequently a high degree of sensitivity can be achieved. The capillary in FIG. 2 is shown attached to the liquid container 40 as an outboard structure, but can also be of the same type as shown in FIG. 1.

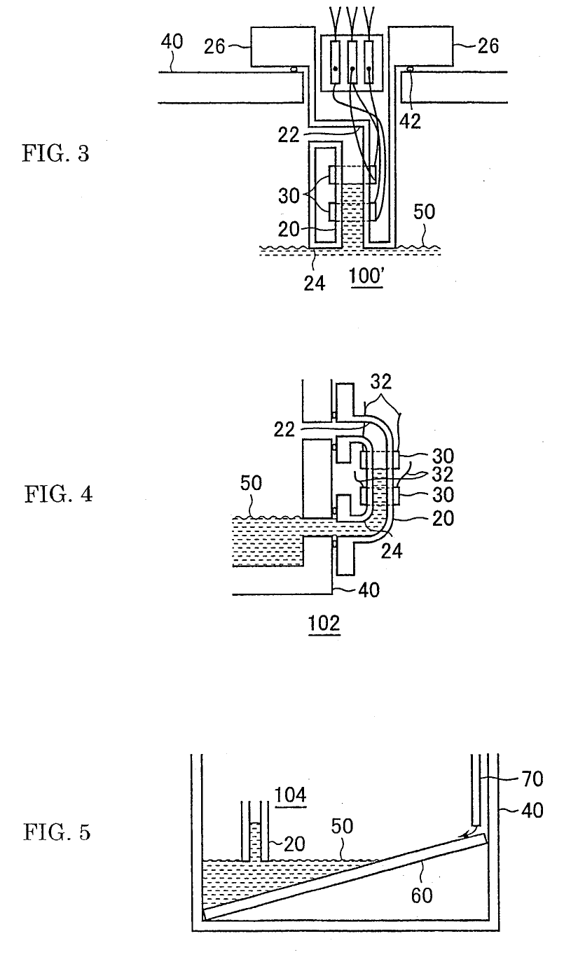

In the liquid level sensing system 100′ of FIG. 3, flanges 26 rest on metal O-rings 42, in fixed relationship to the top of a closed liquid container 40. Within the container, an opening is provided at the upper end 22 of the capillary tube 20. This opening is in communication with the atmosphere above the liquid in the container so that gas pressure will not prevent the liquid from rising in the capillary tube.

In the liquid level sensing system 102 in the embodiment of FIG. 4, the upper end 22 and lower end 24 of a capillary tube 20 extend horizontally and are connected to the side of a liquid container 40 and arranged so that the surface of the liquid in container 40 can reach the upper part of the lower opening of the capillary tube 20. Both openings of the capillary tube are in communication with the inside of the liquid container 40. As in the embodiment of FIG. 3, the upper end of the capillary tube is vented to the interior of the liquid container. The structure of this embodiment is otherwise similar to the structure of the embodiment shown in FIG. 3.

In the embodiment shown in FIG. 5, a liquid level sensing system 104 according to the invention is incorporated into a liquid vaporizing container 40 having an oblique vaporizing plate 60, which is kept at a constant temperature by a heater (not shown) . A nozzle 70 is provided adjacent the upper end of a vaporization plate 20, which consequently provides a large vaporizing area. Part of the liquid which exits from the nozzle 70 and flows down the slope of the vaporization plate 60 is vaporized. The rate at which liquid is supplied by the nozzle 70 is greater than the rate at which the liquid is vaporized. When the liquid surface 50 reaches the lower end 24 of the capillary tube 20 of the liquid level sensing system 104, a liquid level detection signal sent by the sensing system to a flow controller (not shown) temporarily stops the flow of liquid from the nozzle 70. When more liquid is vaporized, and the liquid level falls, the liquid level sensing system 104 provides a signal to the flow controller causing the flow of liquid through the nozzle 70 to resume. The repeated cycling of the flow control in response to the signal provided by the sensing system 104 maintains a desired level of liquid in the vaporizing container, for optimum vaporization.

An important advantage of the invention is that it eliminates the need for a float. Consequently there is no need to provide for the draft depth of a float, and the liquid level sensing system can be miniaturized.

In addition, precise liquid level detection can be achieved using the capillary tube detection system, by setting the diameter of the capillary tube according to the various properties of the liquid, such as surface tension, which affect the height to which the liquid rises in the capillary tube.

What is claimed is:

1. In a liquid container in which the level of a liquid surface varies with changes in the amount of liquid in the system, a liquid level sensor comprising a capillary tube having a lower end located at a position in said system such that it can be reached by said liquid surface, and a thermal sensor on said capillary tube at a position spaced from said lower end, said thermal sensor being responsive to the presence of liquid in said capillary tube in proximity to said position of the thermal sensor, whereby the presence of said liquid surface at the position of said lower end of the capillary tube is detected by said thermal sensor as said liquid rises in the capillary tube and reaches a position in proximity to said position of the thermal sensor.

2. A liquid level sensing system as claimed in claim 1, in which said liquid container has an inside, and in which the capillary tube has upper and lower end openings, both said end openings being connected to, and in communication with, the inside of said liquid container.

3. A liquid level sensing system as claimed in claim 1, wherein the thermal sensor comprises a pair of thermally responsive sensing elements, both in proximity to said position spaced from said lower end of the capillary tube, said thermally responsive sensing elements being disposed in a bridge circuit.

4. A liquid level sensing system as claimed in claim 3, in which said liquid container has an inside, and in which the capillary tube has upper and lower end openings, both said end openings being connected to, and in communication with, the inside of said liquid container.
